(19) United States
(12) Patent Application Publication
(10) Pub. No.: US 2013/0332358 A1
(43) Pub. Date: Dec. 12, 2013

(54) FRAUD DETECTION SYSTEM

(71) Applicant: Lucy Ma Zhao, Austin, TX (US)

(72) Inventor: Lucy Ma Zhao, Austin, TX (US)

(73) Assignee: EBAY, INC., San Jose, CA (US)

(21) Appl. No.: 13/494,741

(22) Filed: Jun. 12, 2012

(51) Int. Cl. G06Q 20/40; G06Q 40/00

(52) U.S. Cl. 705/44

(57) ABSTRACT

A fraud detection system includes a fraud database associating at least one payment account with at least one user device. A system provider device in the fraud detection system is coupled to a network and the fraud database. The system provider device is operable to receive first location data over the network. The first location data is associated with a payment request made using a first payment account from the at least one payment account in the fraud database. The system provider device will then retrieve second location data over the network from a first user device that is associated with the first payment account in the fraud database, determine that the first location data corresponds to a first location that is not within a predetermined distance of a second location corresponding to the second location data, and send a payment authorization request to the first user device.

### BACKGROUND

1. Field of the Invention

The present invention generally relates to payment systems and more particularly to a fraud detection system for use in a payment system.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Both mobile payments and traditional payments made at a point-of-sale of a “brick-and-motor” location are subject to fraud. For example, third parties may steal payment account devices (e.g., credit cards), payment account numbers, and/or other payment account information in order to use the payment account in a manner that has not been authorized by the payment account holder. Conventionally, such fraud is detected by the payment account holder reporting to the payment account provider a missing payment account device and/or an unrecognized payment, or the payment account provider determining that the usage of the payment account does not fit a “spending pattern” associated with the payment account holder. Such conventional fraud detection suffers from several deficiencies, including allowing several payments to be made using the payment account between the time the theft occurs and the payment account holder determines that the theft and/or unrecognized payment(s) has occurred, falsely determining that fraud has occurred with the payment account holder makes an unusual purchase, and/or a variety of other fraud detection system deficiencies known in the art. These deficiencies lead to losses for the payment account providers and/or inconvenience to the payment account holder.

Thus, there is a need for an improved fraud detection system for payment systems.

### SUMMARY

According to one embodiment, a method for detecting fraud includes associating a user device with a payment account in a database. When a payment request to use the payment account is received, first location data is received, retrieved, or otherwise obtained that indicates the location where the payment request is being made. Second location data is then retrieved from the user device. If the first location data is not within a predetermined distance from the second location data, the payment request may be denied. In an embodiment, an authorization request may be sent to the user device associated with the payment account if the first location data is not within a predetermined distance from the second location data, and the user device may be used to either authorize or deny the payment request.

In some embodiments, the first location data may be sent from a merchant device that is attempting to receive a payment according to the payment request. In some embodiments, multiple user devices may be associated with a payment account, and location data may be retrieved from each of those user devices and checked to determine whether any of those user devices are within a predetermined distance of the first location data in order to determine whether to deny the payment request. In some embodiments, the payment account may be disabled in response to denying a payment request.

As a result, a fraud detection may be provided for the payment account by ensuring that it only may be used in the same location as user devices that are associated with it. Thus, e payment account devices and payment account information that is stolen is useless as it cannot be used unless it is in the same location as at least one of the user devices associated with it.

These and other features and advantages of the present disclosure will be more readily apparent from the detailed description of the embodiments set forth below taken in conjunction with the accompanying figures.

### BRIEF DESCRIPTION OF THE FIGURES

FIG. 1 is a flow chart illustrating an embodiment of a method for detecting fraud;

FIG. 2 is a schematic view illustrating an embodiment of a fraud database;

FIG. 3 is a map view illustrating an embodiment of a plurality of locations associated with location data;

FIG. 4a is a front view illustrating an embodiment of a user device receiving a security alert;

FIG. 4b is a front view illustrating an embodiment of a user device receiving a confirmation that a payment request has been denied;

FIG. 5 is a front view illustrating an embodiment of a payment account/user device association page on a payer device;

FIG. 6 is a schematic view illustrating an embodiment of a networked system;

FIG. 7 is a perspective view illustrating an embodiment of a user device;

FIG. 8 is a schematic view illustrating an embodiment of a computer system; and

FIG. 9 is a schematic view illustrating an embodiment of a fraud detection system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for detecting fraud in the use of a payment account. The payment account is associated with a user device in a database. When the payment account is used with a merchant, first location data associated with the physical location of the payment request is received, retrieved, or otherwise obtained. Second location data is then retrieved from the user device associated with the payment account. The first location data is then compared to the second location data to determine whether they are within a predetermined distance of each other. If the first location data is within a predetermined distance of the second location data, an instruction is sent to make a payment according to the payment request using the payment account. In some embodiments, if the first location data is not within a predetermined distance of the second location data, the payment request is automatically denied. In other embodiments, if the first location data is not within a predetermined distance of the second location data, an authorization request is sent to the user device associated with the payment account so that the user of the user device may authorize or deny the payment request.

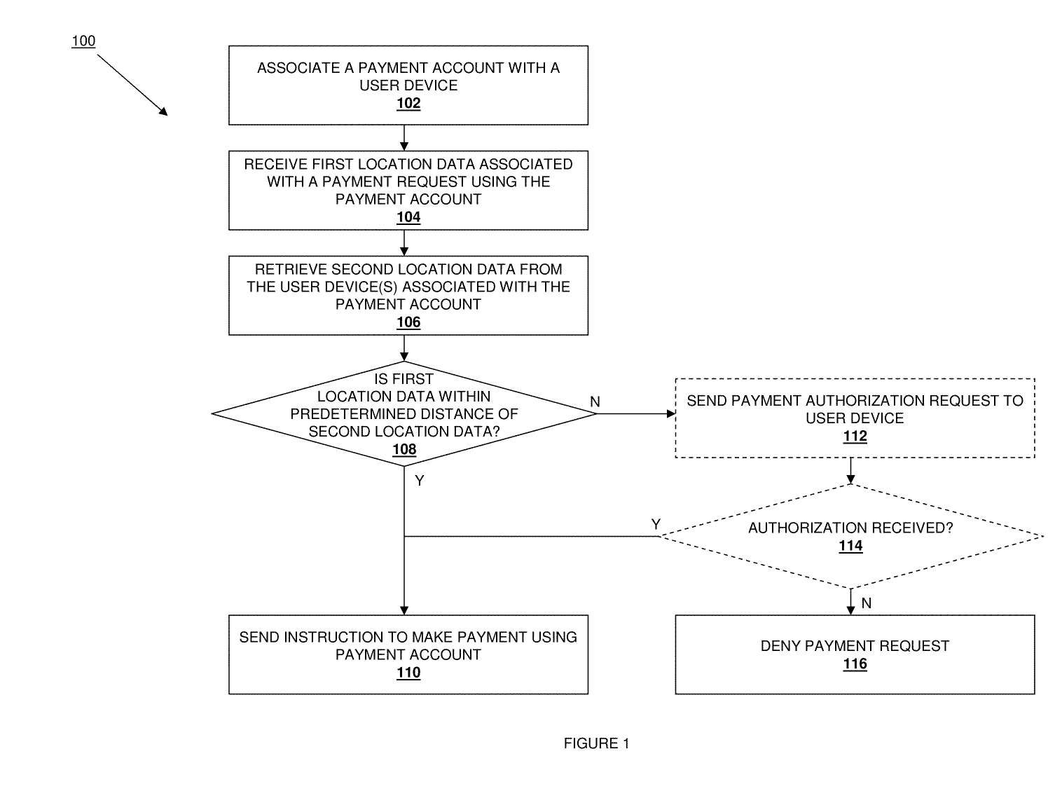

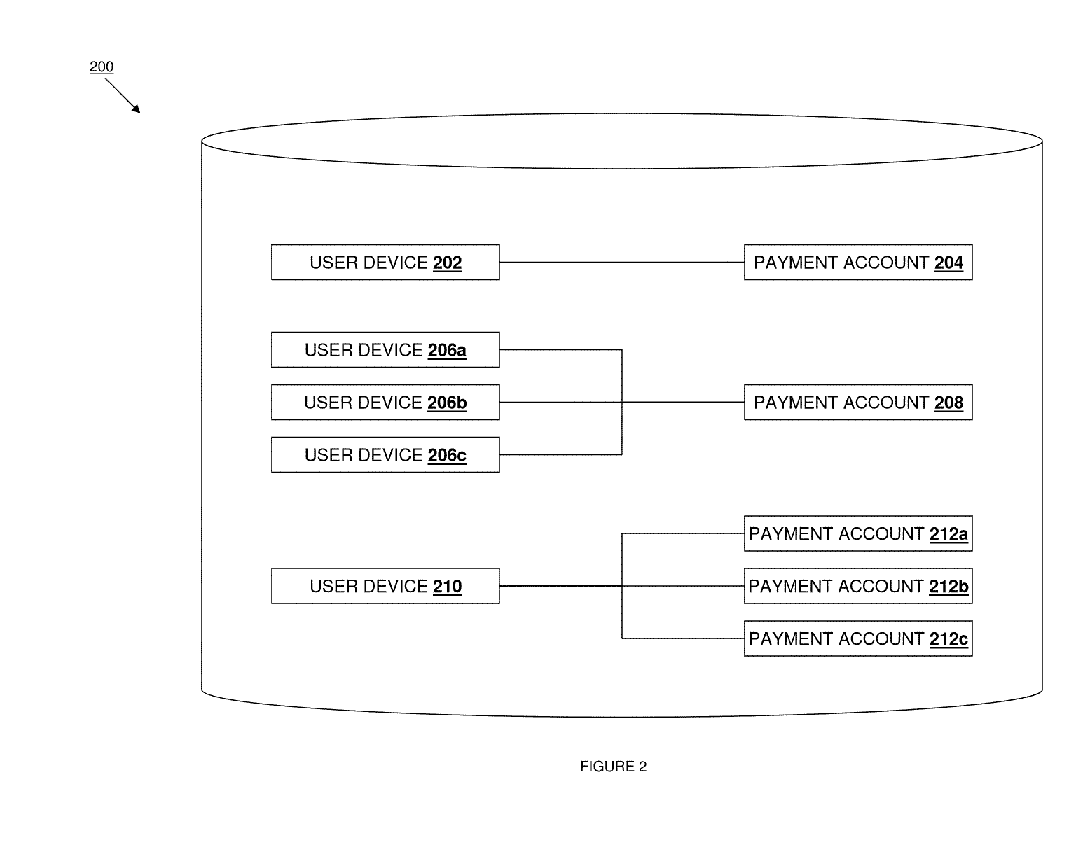

Referring now to FIGS. 1 and 2, a method 100 for detecting fraud is illustrated. In an embodiment of the method 100 described below, an account provider provides a user with a payment account, and the user may use the payment account to fund payments for purchases made from payees. In another embodiment, a payment service provider such as, for example, PayPal, Inc. of San Jose, Calif., assists in the making of payments from the user to the payee by transferring funds from the payment account to a payee account of the payee. However, these embodiments are meant to be merely exemplary, and one of skill in the art will recognize that a variety of modifications may be made to the payment system discussed below without departing from the scope of the present disclosure.

The method 100 begins at block 102 where a payment account is associated with a user device. FIG. 2 illustrates a fraud database 200 for associated payer accounts and user devices. As discussed above, in some embodiments, an account provider may provide payment accounts to users, and the account provider may operate an account provider device that includes or is coupled to the fraud database 200. As also discussed above, a payment service provider may assist in the making of payments from the user to payees by transferring funds from payment accounts provided by account providers, and that payment service provider may operate a payment service provider device that includes or is coupled to the fraud database 200. While a few examples have been provided, the fraud database 200 may be included in or coupled to any fraud detection system provider device or devices to enable the method 100 of the present disclosure.

Block 102 of the method 100 may be performed in response to instructions from a user associated with the payment account and the user device, an account provider that provides the payment account to the user, a payment service provider that assists in transferring funds between the payment account of the user and other payment accounts, and/or from a variety of other payment service entities known in the art. In some of the embodiments discussed below, the user devices may be mobile phones, mobile music listening devices, mobile radios, and/or a variety of other mobile computing user devices known in the art. Furthermore, the payment accounts may include checking accounts, savings accounts, credit accounts, and/or a variety of other payment accounts known in the art.

In one embodiment of block 102, a user device 202 may be associated with a payment account 204 in the fraud database 200, as illustrated in FIG. 2. For example, storing the payment account 204 in the fraud database 200 may include storing a payment account number that identifies the payment account (e.g., 1234 5678 9012 3456), a payment account type (e.g., checking account, savings account, credit account, etc.), a payment account balance that indicates an amount of funds in the payment account, a payment account limit that indicates a maximum amount that may be spent using the payment account, a payment account device type (e.g., a physical card, a user device, etc.), and/or a variety of other payment account attributes of the payment account 204 in the fraud database 200. Furthermore, storing the user device 202 in the fraud database 200 may include storing a user device mobile phone number (e.g., 555-123-4567), a user device user name that indicates the name of the user, a user device type that indicates a make or model of the user device, a user device home location that may indicate where the user of the user device is typically located, and/or a variety of other user device attributes of the user device 202 in the fraud database 200. Associations of the user device 202 and the payment account 204 may be made in the fraud database 200 using database methods known in the art.

In another embodiment of block 102, a plurality of user devices 206a, 206b, and 206c may be associated with a payment account 208 in the fraud database 200, as illustrated in FIG. 2. While only three users devices are illustrated as being associated with the payment account 208, any number of user devices may be associated with a payment account. Similarly to the payment account 204 discussed above, storing the payment account 208 in the fraud database 200 may include storing a payment account number, a payment account type, a payment account balance, a payment account limit, a payment account device type, and/or a variety of other payment account attributes of the payment account 208 in the fraud database 200. Also similarly to the user device 202 discussed above, storing the user devices 206a, 206b, and 206c in the fraud database 200 may include storing user device mobile phone numbers, user device users, user device types, user device home locations, and/or a variety of other user device attributes of the user devices 206a, 206b, and 206c in the fraud database 200. Associations of the user devices 206a, 206b, and 206c and the payment account 208 may be made in the fraud database 200 using database methods known in the art. While a few examples have bee illustrated and described, one of skill in the art will recognize that a variety of other user device/payment account associations will fall within the scope of the present disclosure.

In another embodiment of block 102, a user device 210 may be associated with a plurality of payment accounts 212a, 212b, and 212c in the fraud database 200, as illustrated in FIG. 2. While only three payment accounts are illustrated as being associated with the user device 210, any number of payment accounts may be associated with a user device. Similarly to the payment account 204 discussed above, storing the payment accounts 212a, 212b, and 212c in the fraud database 200 may include storing payment account numbers, payment account types, payment account balances, payment account limits, payment account devices, and/or a variety of other payment account attributes of the payment accounts 212a, 212b, and 212c in the fraud database 200. Also similarly to the user device 202 discussed above, storing the user device 210 in the fraud database 200 may include storing a user device mobile phone number, a user device user, a user device type, a user device home location, and/or a variety of other user device attributes of the user device 210 in the fraud database 200. Associations of the user device 210 and the payment accounts 212a, 212b, and 212c may be made in the fraud database 200 using database methods known in the art. While not illustrated, one of skill in the art will recognize that other user device/payment account associations will fall within the scope of the present disclosure.

The method 100 then proceeds to block 104 where first location data that is associated with a payment request using the payment account is received. First location data may be received, over a network by a fraud detection system provider device, in response to a payment request to use a payment account to make a payment in a variety of ways. While a number of examples are provided below, those examples are not meant to be limiting, and one of skill in the art will recognize that a variety of payment scenarios known in the art may result in the first location data being sent to the fraud detection system provider device.

In one embodiment, the payment request to use the payment account occurs in response to a physical payment instrument (e.g., a credit card, a check card, a check, and/or a variety of physical payment instruments known in the art) being presented to a merchant at the physical location of the merchant. As is known in the art, a physical payment instrument may be provided to a merchant in order to pay the merchant for items (e.g., products, services, etc.) At block 104, the merchant uses a merchant device to send information about the physical payment instrument (e.g., by ‘swiping’ a credit or check card, scanning a check, and/or otherwise inputting the physical payment instrument information), details of the payment (e.g., a payment amount, items being purchased, etc.), and first location data as a payment request over a network to an account provider device or a payment service provider device. In one example, the first location data is included in the payment request as an address or other physical location identifier of the merchant. In another example, the merchant device may include a location determination device such as, for example, a Global Positioning System (GPS) device that is operable to determine the first location data and provide the first location data for the payment request.

In another embodiment, the payment request to use the payment account occurs in response to a payer device (e.g., a mobile phone and/or other mobile computing device) being used to make a payment by providing payment account information to a merchant at the physical location of the merchant. As is known in the art, a mobile payer device may be used in order to pay a merchant for items (e.g., products, services, etc.) At block 104, the merchant uses a merchant device to send the payer account information received from the payer device, details of the payment (e.g., a payment amount, items being purchased, etc.), and first location data as a payment request over a network to an account provider device or a payment service provider device. In one example, the first location data is included in the payment request as an address or other physical location identifier of the merchant. In another example, the merchant device may include a location determination device such as, for example, a Global Positioning System (GPS) device that is operable to determine the first location data and provide the first location data for the payment request.

In another embodiment, the payment request to use the payment account occurs in response to a payer device (e.g., a mobile phone, a laptop computer, a desktop computer, and/or a variety of other computing devices known in the art) being used to make a payment by providing payment account information over the network to an account provider device or a payment service provider device. As is known in the art, a payer device may be used in order to pay a merchant for items (e.g., products, services, etc.) At block 104, the payer device sends payment account information, details of the payment (e.g., a payment amount, items being purchased, etc.), and first location data as a payment request over a network to an account provider device or a payment service provider device. In one example, the payer device may include a location determination device such as, for example, a Global Positioning System (GPS) device that is operable to determine the first location data and provide the first location data for the payment request. In this embodiment, the payer device may be required to retrieve its current location (i.e., the first location data) in order to provide the payment request.

The method 300 then proceeds to block 106 where second location data is retrieved from the user device or devices associated with the payment account. In embodiments where the fraud detection system is provided by the account provider or the payment service provider, the fraud detection system provider device and the account provider device or payment service provider device may be the same, and the receiving the payment request at block 104 may cause the fraud detection system provider device to retrieve the second location data at block 106. In some embodiments, the payment request received in block 104 or information from the payment request my be forwarded over the network by the receiving device to the fraud detection system provider device (e.g., from the account provider device to the payment service provider device, from the account provider device to a third-party device, from the payment service provider device to a third-party device, etc.) to cause the fraud detection system provider device to retrieve the second location data at block 106.

Each user device associated with the payment account in the fraud database 200 includes a location determination device (e.g., a GPS device and/or other location determination device known in the art) that operable to determine the current location of that user device. In an embodiment, at block 106 of the method 100, the fraud detection system provider device may send an instruction over the network to each user device associated with the payment account for which the payment request was received in block 104, and that instruction may include directions to determine and send the current location of the user device. Thus, at block 106, the fraud detection system provider device may retrieve second location data over the network from a second user device associated with the payment account for which the payment request was received in block 104, third location data over the network from a third user device associated with the payment account for which the payment request was received in block 104, and so on.

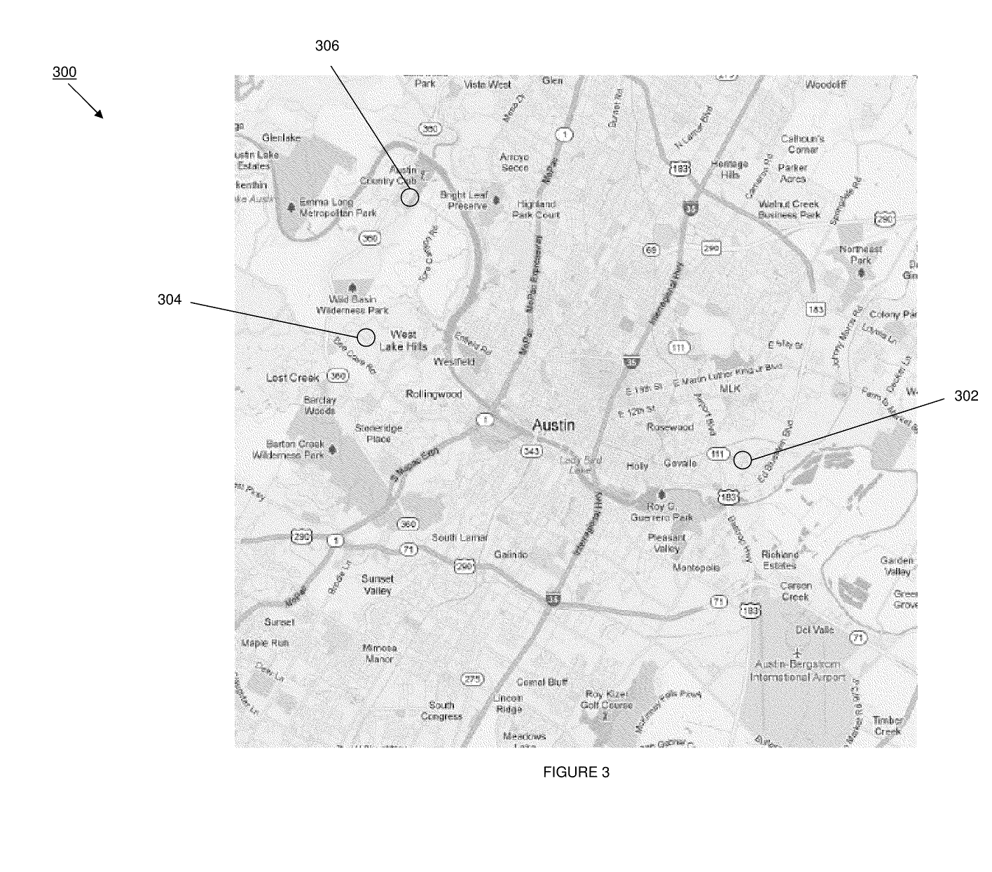

Referring now to FIGS. 1 and 3, the method 100 then proceeds to decision block 108 where the fraud detection system provider device determines whether the first location data corresponds to a first location that is within a predetermined distance of a second location corresponding to the second location data. As is know in the art, location data may correspond to physical locations. For example, FIG. 3 illustrates a map 300 including a first location 302 corresponding to location data received during the method 100, a second location 304 corresponding to location data received during the method 100, and a third location 304 corresponding to third location data received during the method 100. At decision block 108, the fraud detection system provider device may user methods known in the art to determine whether the location data received in block 104 is within a predetermined distance of the location data received in block 106. In an embodiment, the predetermined distance may be relatively small (e.g., 5 to 10 feet) or relatively large (e.g., 1 to 2 miles) depending on the level of security desired for the payment account. For example, a user may wish to not allow any purchases using their payment account unless their user device is in the same location, and thus may set the predetermined distance to the minimum abilities of the location determination device on their user device and/or the merchant device. In other examples, the user may wish to allow purchases using their payment account when their user device is relative close but not in the same location (e.g., when the user leaves their mobile phone in their car and goes to into a mall or park), and thus may set the predetermined distance to the appropriate amount for their needs. While a few examples of the determination made at decision block 108 are illustrated below, one of skill in the art will recognize that a variety of scenarios will fall within the scope of the present disclosure.

In one example, the first location 302 may correspond to both the first location data received at block 104 the method 100 and the second location data received at block 106 of the method 100. Thus, at decision block 108, the fraud detection system provider device may determine that the first location data is within a predetermined distance from the second location data.

In another example, the first location 302 may correspond to the first location data received at block 104 the method 100 and the second location 304 may correspond to the second location data received at block 106 of the method 100. At decision block 108, the fraud detection system provider device may calculate the distance between the first location 302 and the second location 304, retrieve the predetermined distance from the fraud database, and determine whether the first location 302 is more than the predetermined distance from the second location 304.

In another example, the first location 302 may correspond to the first location data received at block 104 the method 100 and the second location 304 and third location 306 may correspond to the second location data and third location data received at block 106 of the method 100. At decision block 108, the fraud detection system provider device may calculate the distance between the first location 302 and each of the second location 304 and the third location 306, retrieve the predetermined distance from the fraud database, and determine whether the first location 302 is more than the predetermined distance from either the second location 304 or the third location 306.

In another example, the first location 302 may correspond to both the first location data received at block 104 the method 100 and second location data received at block 106 of the method 100, while the second location 304 and third location 306 may correspond to the third location data and fourth location data received at block 106 of the method 100. Thus, at decision block 108, the fraud detection system provider device may determine that the first location data is within a predetermined distance from the second location data.

In the examples above, the distance determined between any two locations may be determined as a straight line distance between two points, a driving distance, a walking distance, and/or using a variety of other distance determination methods known in the art.

If, at decision block 108, the fraud detection system provider device determines that the first location is within a predetermined distance from the second location, the method 100 then proceeds to block 110 where an instruction is sent to make a payment according to the payment request received in block 104 using the payment account. In some embodiments, the fraud detection system provider device is provided by the account provider device or the payment service provider device, and at block 110, an instruction is sent by the account provider device or the payment service provider device to make a payment using the payment account in response to determining that the first location data is within a predetermined distance from the second location data. In other embodiments, the fraud detection system provider device provides an indication that the first location data has been determined to be within a predetermined distance from the second location data over the network to the account provider device or the payment service provider device, and at block 110, an instruction is sent by the account provider device or the payment service provider device to make a payment using the payment account. In response to the instruction sent to make the payment using the payment account, funds are transferred from the payment account to a merchant account according to the payment request received in block 104.

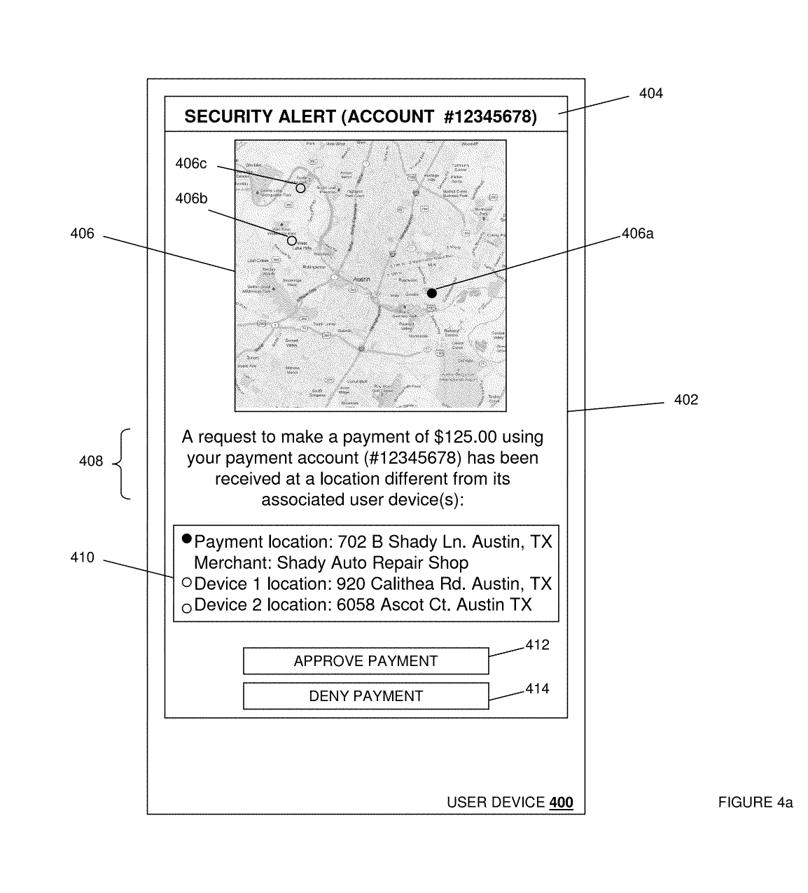

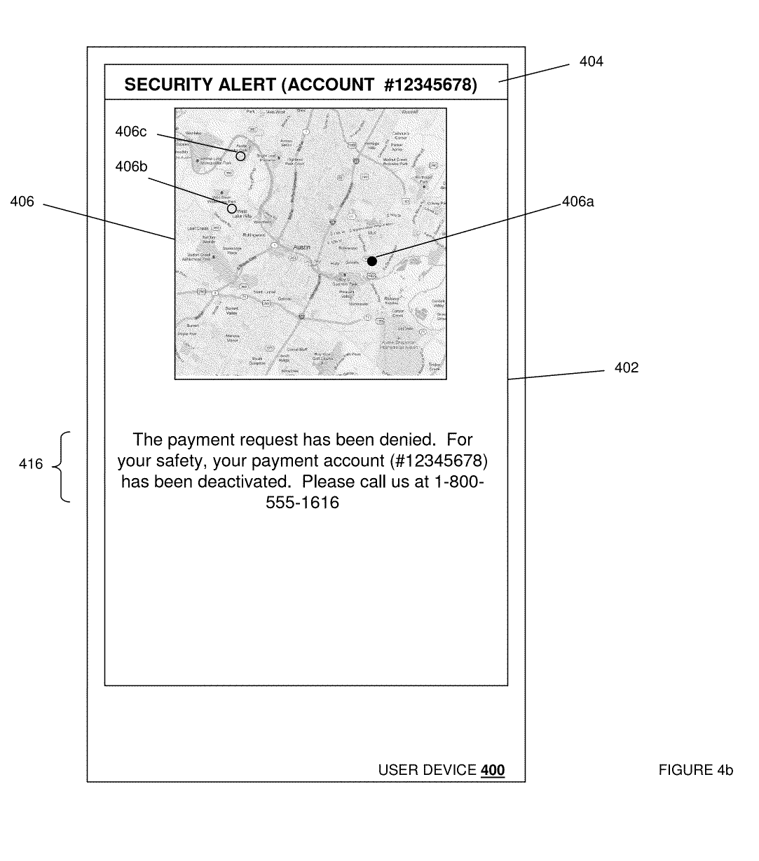

Referring now to FIGS. 1 and 4a, if at decision block 108, the fraud detection system provider device determines that the first location data is not within a predetermined distance of the second location data, the method 100 may then proceed to optional block 112 where a payment authorization request may be sent to a user device associated with the payment account for which the payment request was received in block 104. In some embodiments, a single user device may be associated with the payment account, and at block 112 the fraud detection system provider device sends a payment authorization request over the network to that user device. In some embodiments, multiple user devices may be associated with the payment account, and at block 112 the fraud detection system provider device sends a payment authorization request over the network to a primary user device designated from the multiple user devices, discussed in more detail below. In some embodiments, multiple user devices may be associated with the payment account, and at block 112 the fraud detection system provider device sends a payment authorization request over the network to two or more of the multiple user devices.

FIG. 4a illustrates an embodiment of a user device 400 including a display 402. While the user device 400 is illustrated and described below as a mobile phone, one of skill in the art will recognize that the user device 400 may include a variety of other computing devices known in the art. At block 112 of the method 100, the fraud detection system provider device sends a security alert 404 to the user device 400 over the network. The security alert 404 may be provided on the user device 400 in a variety of ways such as, for example, as a “pop-up” window, in a text message, as an email, through an application stored on the user device 400, and/or using a variety of other methods known in the art. Furthermore, while the security alert 404 in the illustrated embodiment is displayed on a display screen, in some embodiments, security alerts may be provided as audio (e.g., as an auto-call to the user device).

In the illustrated embodiment, the security alert 404 includes a graphical map section 406 having a plurality of location identifiers 406a, 406b, and 406c provided on the graphical map section 406. For example, the fraud detection system provider device may use the location data received in block 104 and retrieved in block 106 to provide the graphical map section 406 with the plurality of location identifiers 406a, 406b, and 406c (which correspond to the first location 302, the second location 304, and the third location 306, respectively, illustrated on the map 300 of FIG. 3.) The security alert 404 also includes a payment request information section 408 that includes details of the payment request received in block 104 such as, for example, a payment amount, an payment account number, and an indication that the payment request was received from a location that is different from its associated user device or devices. The security alert 404 also includes a legend 410 that provide details about the location identifiers such as, for example, which location identifier corresponds to the location that the payment request was received from, which location identifiers correspond to the locations of the user devices associated with the payment account for which the payment request was received, a merchant associated with the location that the payment request was received from, an address for the location that the payment request was received from, addresses for the locations of the associated user devices, and/or a variety of other information that is associated with the payment request, the merchant associated with the payment request, and/or the user devices associated with the payment account. The security alert 404 also includes an approve payment button 412 and a deny payment button 414.

Thus, the security alert 404 provided on the user device 400 over the network from the fraud detection system provider device alerts a user of the user device 400 when a payment request is being made using a payment account that is associated with the user device 400, and that payment request is being made at a different location than the associated user device 400. The user of the user device 400 may review the security alert 404 to quickly and easily determine where the payment request is being made from, where the associated user devices are currently located, and the details of the payment request in order to determine whether the payment request using the payment account should be authorized. The graphical map section 406 may provide some features that are not illustrated such as, for example, a phone number of the merchant with whom the payment request is being made when the user selects the location identifier 406a, phones numbers of the user devices associated with the payment account with the user selects the location identifiers 406b or 406c, and/or a variety of other information associated with the merchant, the payment request, and/or the user devices.

Following optional block 112, the method 100 then proceeds to optional decision block 114 where the fraud detection system provider device determines whether an authorization 114 has been received. In an embodiment, after reviewing the security alert 404, the user of the user device 400 may determine that the payment request should be authorized (e.g., because the user has provided someone without an associated user device a payment account instrument in order to make a purchase), and selects the approve payment button 412. In response, an authorization is sent over the network from the user device 400 to the fraud detection system provider device. Upon receiving the authorization, the fraud detection system provider device determines at optional decision block 114 that the authorization has been received, and the method 100 proceeds to block 110 where an instruction is sent to make a payment using the payment account according to the payment request substantially as described above.

In an embodiment, the user of the user device 400 may review the security alert 404, determine that the payment request should be denied, and select the deny payment button 414. In response, a deny payment message is sent over the network from the user device 400 to the fraud detection system provider device. Upon receiving the deny payment message, the fraud detection system provider device determines at optional decision block 114 that the authorization has not been received, and the method 100 proceeds to block 110 where the payment request is denied. In an embodiment, the fraud detection system is provided by the account provider or the payment service provider, and at block 110 the account provider device or the payment service provider device sends a message over the network to the merchant device that the payment request has been denied. In another embodiment, the fraud detection system provider devices sends a message over the network to the account provider device or the payment service provider device that the payment request has been denied, and the account provider device or the payment service provider device sends a message over the network to the merchant device that the payment request has been denied. In other embodiments, the fraud detection system provider device may determine that an authorization has not been received at optional decision block 114 if no authorization or deny message is received in a predetermined amount of time.

Referring now to FIG. 4b, in an embodiment, the fraud detection system provider device may provide the security alert 202 to the user device 400 over the network substantially as described above, but with a deny notification 416 replacing the payment request information section 408, the legend 410, the approve payment button 412, and the deny payment button 414. The deny notification 416 may include an indication that the payment request has been denied, a message that the payment account associated with the payment request has been deactivated, and a request to call the account provider, payment service provider, and/or the fraud detection system provider. As indicated in FIG. 4b, the payment account associated with the payment request received in block 104 may be deactivated upon determining that an authorization has not been received at optional decision block 114. For example, the account provider may provide the fraud detection system, and at block 116 the account provider may deactivate the payment account. In another example, the payment service provider may provide the fraud detection system, and at block 116 the payment service provider may deactivate the payment account or send the account provider instructions to deactivate the payment account. In another example, at block 116 the fraud detection system may send the account provider or the payment service provider instructions to deactivate the payment account.

As discussed above, optional blocks 112 and optional decision block 114 may not be included in the method 100. In such an embodiment, following the determination that the first location data is not within a predetermined distance of the second location data at decision block 108, the method 100 may proceed to block 116 where the fraud detection system provider device denies the payment request substantially as described above.

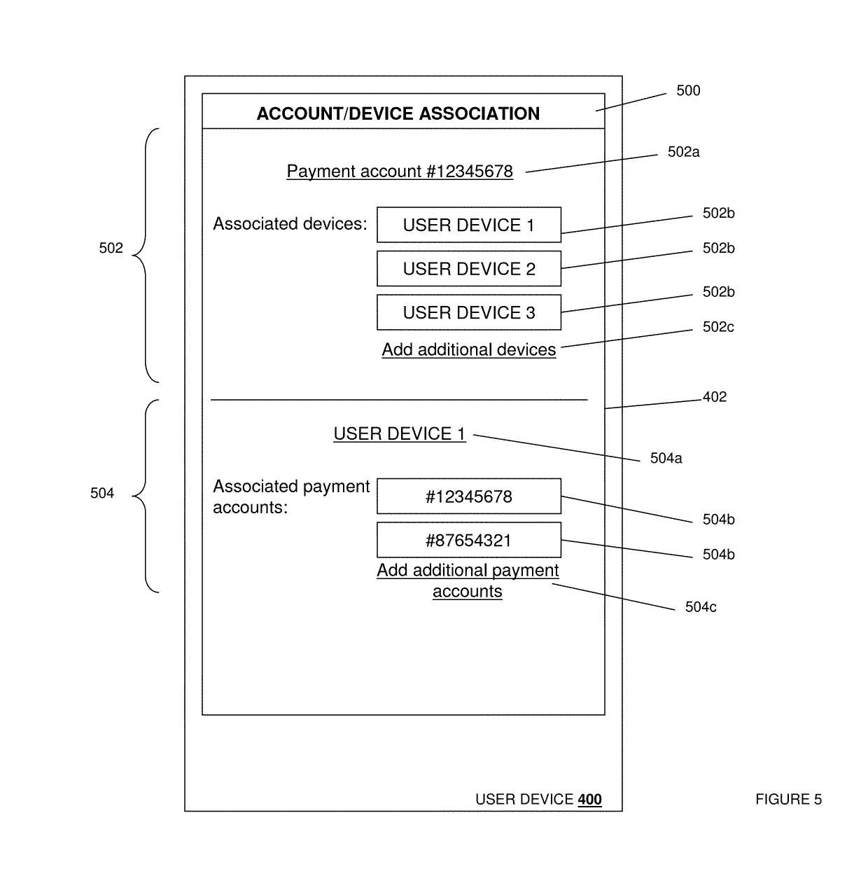

Referring now to FIG. 5, an embodiment of block 102 of the method 100 is illustrated where one or more payment accounts are associated with one or more user devices. In one embodiment, the user device 400 may receive, over the network from the fraud detection system provider device, an account/device association page 500 and display it on the display 402. In another embodiment, the account/device association page 500 may be provided by an application that is stored on the user device 400 and that can communicate the association information discussed below over the network to the fraud detection system provider device. The account/device association page 500 includes a first association section 502 and a second association section 504.

The first association section 502 is for associating user devices with a particular payment account, and thus includes a payment account identifier 502a along with a plurality of user devices 502b that have been associated with the payment account associated with the payment account identifier 502a. The user may associated additional user devices with the payment account associated with the payment account identifier 502a using the add additional devices link 502c, and may disassociate the user devices 502b from the payment account associated with the payment account identifier 502a using methods know in the art.

The second association section 504 is for associating payment accounts with a particular user device, and thus includes a user device identifier 504a along with a plurality of payment accounts 504b that have been associated with the user device associated with the user device identifier 504a. The user may associated additional payment accounts with the user device associated with the user device identifier 504a using the add additional payment accounts link 504c, and may disassociate the payment accounts 504b from the user device associated with the user device identifier 502a using methods know in the art.

While the association of payment accounts and user devices has been illustrated in FIG. 5 as either the association of one payment account with multiple user devices or one user device with multiple payment accounts, one of skill in the art will recognize that multiple payment accounts may be associated with multiple user devices in a single account/device association section without departing from the scope of the present disclosure. Furthermore, additional fraud detection system options not illustrated in FIG. 5 may be selected by a user of the user device. For example, the predetermined distance may be set by the user, settings may be provided that instruct the fraud detection device what to do in response to a payment request received from a different location than the user device (e.g., automatic denial of the payment request, the sending of the authorization request to one or more user devices, etc.), settings may be provided that designate a primary user device relative to an associated payment account and other users devices associated with that payment account, and/or a variety of other fraud detection options known in the art. In other examples, settings may be provided that allow a user to quickly and easily associate a payment account with one of a plurality of user devices belonging to a user (e.g., depending on which user device the user has with them at the moment.)

Thus, a system and method for detecting fraud is provided that allows a payment account holder or other entity related to the payment account to associate that payment account with a user device that the user typically carries with them. When a request to use the payment account is received, location data that indicates the location of that payment request is received, retrieved, or otherwise obtained. Location data is then retrieved from the user device associated with that payment account and a determination is made whether the location of the payment request and the location of the user device are the same: if those locations are the same, the payment request may be automatically authorized; if those locations are different, the payment request may be automatically denied, or else authorization for that payment request may be requested from the payment account holder. Such systems and methods provide security for a payment account holder when an attempt to use their payment account is made in a location that is different from the payment account holder and their user device. In one example, the systems and methods of the present embodiment may be used to restrict the use of a credit card to the same location as a mobile user device such that if the credit card is stolen from a user of the user device, payment requests made using that credit card will be denied.

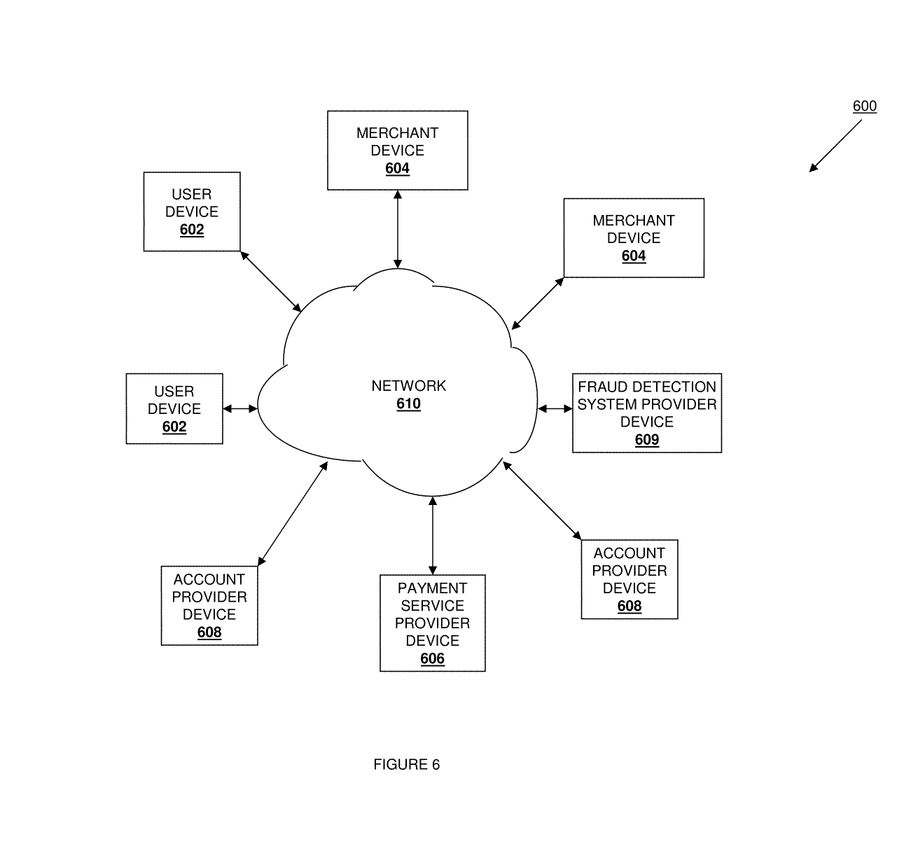

Referring now to FIG. 6, an embodiment of a networked system 600 used in the fraud detection system described above is illustrated. The networked system 600 includes a plurality of user devices 602, a plurality of merchant devices 604, a payment service provider device 606, and a plurality of account holder devices 608, and/or a fraud detection system provider device 609 in communication over a network 610. Any of the user devices 602 may be the user device 400, discussed above. The merchant devices 604 may be the merchant devices discussed above and may be operated by the merchants discussed above. The payment service provider device 606 may be the payment service provider devices discussed above and may be operated by a payment service provider such as, for example, PayPal Inc. of San Jose, Calif. The account provider devices 608 may be the account provider devices discussed above and may be operated by the account providers discussed above such as, for example, credit card account providers, bank account providers, savings account providers, and a variety of other account providers known in the art. The fraud detection system provider device 609 may be the fraud detection system provider device 609 discussed above and may be operated by the fraud detection system provider discussed above.

The user devices 602, merchant devices 604, payment service provider device 606, account provider devices 608, and/or fraud detection system provider device 609 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 600, and/or accessible over the network 610.

The network 610 may be implemented as a single network or a combination of multiple networks. For example, in various embodiments, the network 610 may include the Internet and/or one or more intranets, landline networks, wireless networks, and/or other appropriate types of networks.

The user devices 602 may be implemented using any appropriate combination of hardware and/or software configured for wired and/or wireless communication over network 610. For example, in one embodiment, the user devices 602 may be implemented as a personal computer of a user in communication with the Internet. In other embodiments, the user devices 602 may include smart phones, personal digital assistants (PDAs), laptop computers, music playing devices, and/or other types of computing devices.

The user devices 602 may include one or more browser applications which may be used, for example, to provide a convenient interface to permit the user to browse information available over the network 610. For example, in one embodiment, the browser application may be implemented as a web browser configured to view information available over the Internet.

The user devices 602 may also include one or more toolbar applications which may be used, for example, to provide user-side processing for performing desired tasks in response to operations selected by the user. In one embodiment, the toolbar application may display a user interface in connection with the browser application.

The user devices 602 may further include other applications as may be desired in particular embodiments to provide desired features to the user devices 602. In particular, the other applications may include a payment application for payments assisted by a payment service provider through the payment service provider device 606. The other applications may also include security applications for implementing user-side security features, programmatic user applications for interfacing with appropriate application programming interfaces (APIs) over the network 610, or other types of applications. Email and/or text applications may also be included, which allow the user to send and receive emails and/or text messages through the network 610. The user devices 602 include one or more user and/or device identifiers which may be implemented, for example, as operating system registry entries, cookies associated with the browser application, identifiers associated with hardware of the user devices 602, or other appropriate identifiers, such as a phone number. In one embodiment, the user identifier may be used by the payment service provider device 606, account provider device 608, and/or fraud detection system provider device 609 to associate the user with a particular account as further described herein.

The merchant devices 604 may be maintained, for example, by a conventional or on-line merchant, conventional or digital goods seller, individual seller, and/or application developer offering various products and/or services in exchange for payment to be received conventionally or over the network 610. In this regard, the merchant devices 604 may include a database identifying available products and/or services (e.g., collectively referred to as items) which may be made available for viewing and purchase by the payer.

The merchant devices 604 also includes a checkout application which may be configured to facilitate the purchase by the payer of items. The checkout application may be configured to accept payment information from the user through the user device 602, the account provider through the account provider device 608, and/or from the payment service provider through the payment service provider device 606 over the network 610.

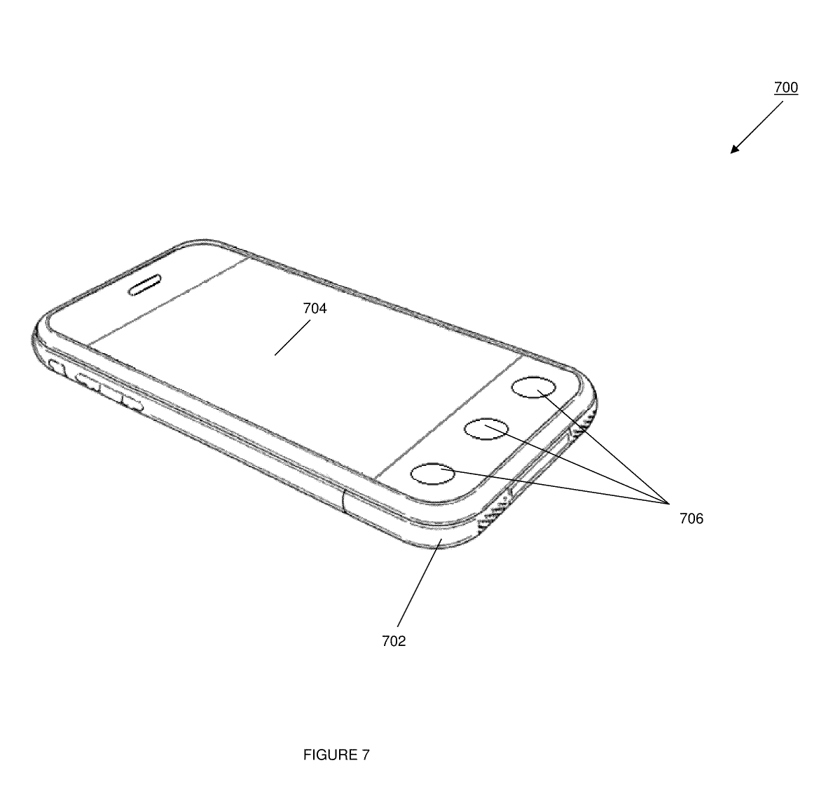

Referring now to FIG. 7, an embodiment of a user device 700 is illustrated. The user device 700 may be the user devices 400 and/or 602. The user device 700 includes a chassis 702 having a display 704 and an input device including the display 704 and a plurality of input buttons 706. One of skill in the art will recognize that the user device 700 is a portable or mobile phone including a touch screen input device and a plurality of input buttons that allow the functionality discussed above with reference to the method 100. However, a variety of other portable/mobile user devices and/or desktop user devices may be used in the method 100 without departing from the scope of the present disclosure.

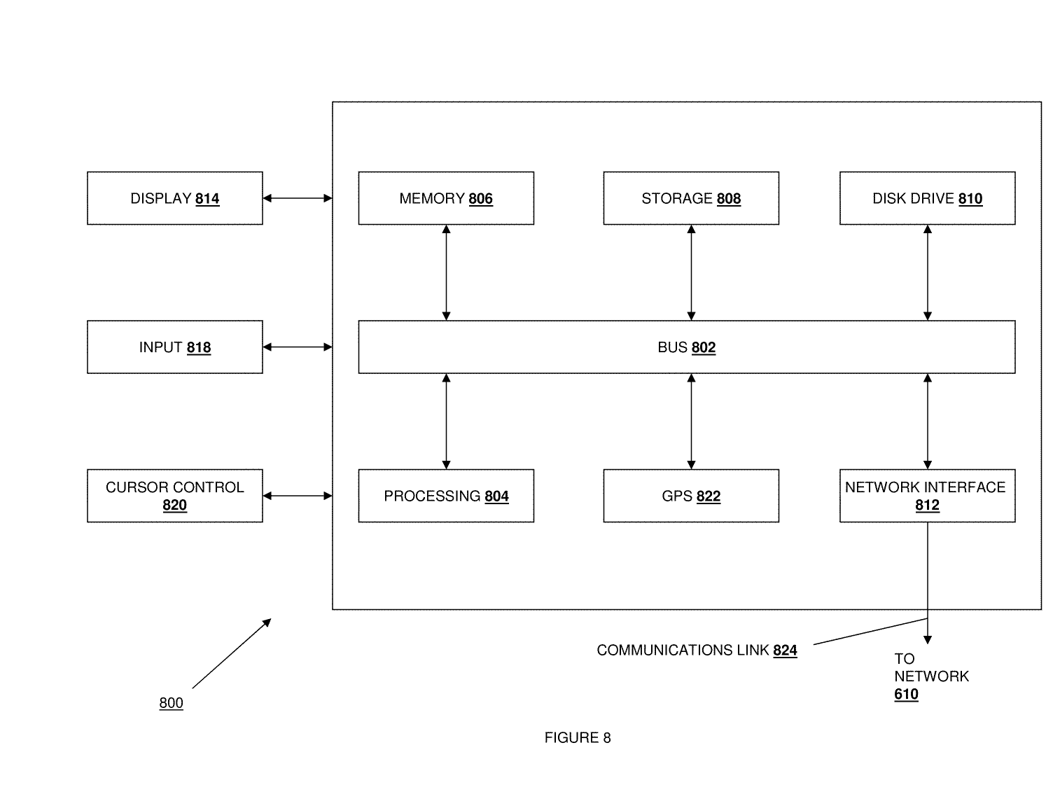

Referring now to FIG. 8, an embodiment of a computer system 800 suitable for implementing, for example, the user device 400, the user devices 602, the user device 700, the merchant devices 604, the payment service provider device 606, the account provider device 608, and/or the fraud detection system provider device 609 is illustrated. It should be appreciated that other devices utilized by payer, payees, payment service providers, and account providers in the payment system discussed above may be implemented as the computer system 800 in a manner as follows.

In accordance with various embodiments of the present disclosure, computer system 800, such as a computer and/or a network server, includes a bus 802 or other communication mechanism for communicating information, which interconnects subsystems and components, such as a processing component 804 (e.g., processor, micro-controller, digital signal processor (DSP), etc.), a system memory component 806 (e.g., RAM), a static storage component 808 (e.g., ROM), a disk drive component 810 (e.g., magnetic or optical), a network interface component 812 (e.g., modem or Ethernet card), a display component 814 (e.g., CRT or LCD), an input component 818 (e.g., keyboard, keypad, or virtual keyboard), a cursor control component 820 (e.g., mouse, pointer, or trackball), and/or a location determination component 822 (e.g., a Global Positioning System (GPS) device as illustrated, a cell tower triangulation device, and/or a variety of other location determination devices known in the art.) In one implementation, the disk drive component 810 may comprise a database having one or more disk drive components.

In accordance with embodiments of the present disclosure, the computer system 800 performs specific operations by the processor 804 executing one or more sequences of instructions contained in the memory component 806, such as described herein with respect to the user devices 400, 602, and 700, the merchant device(s) 604, the payment service provider device 606, the account provider device(s) 608, and/or the fraud detection system provider device 609. Such instructions may be read into the system memory component 806 from another computer readable medium, such as the static storage component 808 or the disk drive component 810. In other embodiments, hard-wired circuitry may be used in place of or in combination with software instructions to implement the present disclosure.

Logic may be encoded in a computer readable medium, which may refer to any medium that participates in providing instructions to the processor 804 for execution. Such a medium may take many forms, including but not limited to, non-volatile media, volatile media, and transmission media. In many embodiments, the computer readable medium is non-transitory. In various implementations, non-volatile media includes optical or magnetic disks, such as the disk drive component 810, volatile media includes dynamic memory, such as the system memory component 806, and transmission media includes coaxial cables, copper wire, and fiber optics, including wires that comprise the bus 802. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by the computer system 800. In various other embodiments of the present disclosure, a plurality of the computer systems 800 coupled by a communication link 824 to the network 610 (e.g., such as a LAN, WLAN, PTSN, and/or various other wired or wireless networks, including telecommunications, mobile, and cellular phone networks) may perform instruction sequences to practice the present disclosure in coordination with one another.

The computer system 800 may transmit and receive messages, data, information and instructions, including one or more programs (i.e., application code) through the communication link 824 and the network interface component 812. The network interface component 812 may include an antenna, either separate or integrated, to enable transmission and reception via the communication link 824. Received program code may be executed by processor 804 as received and/or stored in disk drive component 810 or some other non-volatile storage component for execution.

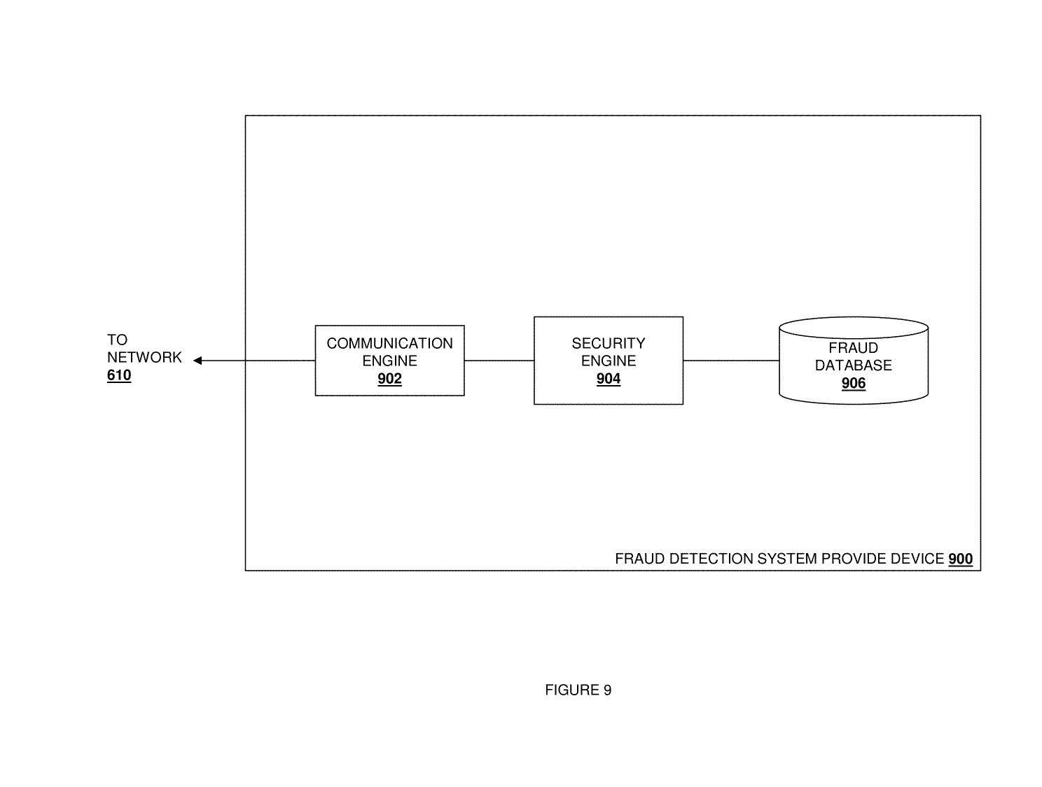

Referring now to FIG. 9, an embodiment of a fraud detection system provide device 900 is illustrated. In an embodiment, the device 900 may be the payment service provider device 606, the account holder device 608, and/or a variety of other devices known in the art. The device 900 includes a communication engine 902 that is coupled to the network 610 and to a security engine 904 that is coupled to a fraud database 906. The communication engine 902 may be software or instructions stored on a computer-readable medium that allows the device 900 to send and receive information over the network 610. The fraud detection engine 904 may be software or instructions stored on a computer-readable medium that is operable to receive payment requests over the network, receive and/or retrieve location data over the network, determine whether locations are within a predetermined distance of each other, send payment authorization requests, associate and disassociate payment accounts and user devices in the fraud database 906, deactivate payment accounts, and provide any of the other functionality that is discussed above. While the database 906 has been illustrated as located in the fraud detection system provider device 900, one of skill in the art will recognize that it may be connected to the security engine 904 through the network 210 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on users and merchants; however, a user or consumer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a payer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A fraud detection system, comprising:
a fraud database including at least one payment account associated with at least one user device;
a system provider device coupled to a network and the fraud database, wherein the system provider device is operable to:
receive a first location data over the network, wherein the first location data is associated with a payment request made using a first payment account from the at least one payment account in the fraud database;
retrieve a second location data over the network from a first user device of the at least one user device that is associated with the first payment account in the fraud database; and
determine that the first location data corresponds to a first location that is not within a predetermined distance of a second location corresponding to the second location data and, in response, deny the payment request.

2. The system of claim 1, wherein the first location data is received over the network from a merchant device attempting to receive a payment according to the payment request.

3. The system of claim 1, wherein the first location data is received over the network from a payer device that is attempting to make a payment according to the payment request.

4. The system of claim 1, wherein the system provider device is further operable to:
retrieve a third location data over the network from a third user device of the at least one user device that is associated with the first payment account in the fraud database; and
determine that the first location data is not within a predetermined distance of a third location corresponding to the third location data, wherein the payment request is denied in response to determining that the first location is not within the predetermined distance of the second location and the third location.

5. The system of claim 1, wherein the system provider device is further operable to:
deactivate the first payment account in response to denying the payment request.

6. The system of claim 1, wherein the system provider device is further operable to:
receive a designation of the first user device for association with the first payment account over the network from a payment account holder of the first payment account; and
associate the first user device with the first payment account in the fraud database.

7. The system of claim 1, wherein the system provider device is further operable to:
send a payment authorization request to the first user device in response to determining that the first location is not within the predetermined distance of the second location, wherein the payment request is denied in response to receiving an authorization denial from the first user device.

8. A method for detecting fraud, comprising:
associating at least one payment account with at least one user device in a fraud database;
receiving a first location data over a network, wherein the first location data is associated with a payment request made using a first payment account from the at least one payment account in the fraud database;
retrieving a second location data over the network from a first user device of the at least one user device that is associated with the first payment account in the fraud database; and
determining that the first location data corresponds to a first location that is not within a predetermined distance of a second location corresponding to the second location data and, in response, denying the payment request.

9. The method of claim 8, wherein the first location data is received over the network from a merchant device attempting to receive a payment according to the payment request.

10. The method of claim 8, wherein the first location data is received over the network from a payer device that is attempting to make a payment according to the payment request.

11. The method of claim 8, further comprising:
retrieving a third location data over the network from a third user device of the at least one user device that is associated with the first payment account in the fraud database; and
determining that the first location is not within a predetermined distance of a third location corresponding to the third location data, wherein the payment request is denied in response to determining that the first location is not within the predetermined distance of the second location and the third location.

12. The method of claim 8, further comprising:
deactivating the first payment account in response to denying the payment request.

13. The method of claim 8, further comprising:
receiving a designation of the first user device for association with the first payment account over the network from a payment account holder of the first payment account; and
associating the first user device with the first payment account in the fraud database.

14. The method of claim 8, further comprising:
sending a payment authorization request to the first user device in response to determining that the first location is not within the predetermined distance of the second location, wherein the payment request is denied in response to receiving an authorization denial from the first user device.

15. A non-transitory machine-readable medium comprising a plurality of machine-readable instructions which, when executed by one or more processors, are adapted to cause the one or more processors to perform a method comprising:
associating at least one payment account with at least one user device in a fraud database;
receiving a first location data over a network, wherein the first location data is associated with a payment request made using a first payment account from the at least one payment account in the fraud database;
retrieving a second location data over the network from a first user device of the at least one user device that is associated with the first payment account in the fraud database; and
determining that the first location data corresponds to a first location that is not within a predetermined distance of a second location corresponding to the second location data and, in response, denying the payment request.

16. The non-transitory machine-readable medium of claim 15, wherein the first location data is received over the network from one of a merchant device attempting to receive a payment according to the payment request and a payer device that is attempting to make a payment according to the payment request.

17. The non-transitory machine-readable medium of claim 15, wherein the method further comprises:
sending a payment authorization request to the first user device in response to determining that the first location is not within the predetermined distance of the second location, wherein the payment request is denied in response to receiving an authorization denial from the first user device.

18. The non-transitory machine-readable medium of claim 15, wherein the method further comprises:
retrieving a third location data over the network from a third user device of the at least one user device that is associated with the first payment account in the fraud database; and
determining that the first location is not within a predetermined distance of a third location corresponding to the third location data, wherein the payment request is denied in response to determining that the first location is not within the predetermined distance of the second location and the third location.

19. The non-transitory machine-readable medium of claim 15, wherein the method further comprises:
deactivate the first payment account in response to denying the payment request.

20. The non-transitory machine-readable medium of claim 15, wherein the method further comprises:
receiving a designation of a first user device for association with the first payment account over the network from a payment account holder of the first payment account;
associating the first user device with the first payment account in the fraud database;
receiving a request to disassociate the first user device and the first payment account over the network from the payment account holder of the first payment account; and
disassociating the first user device and the first payment account in the fraud database.
